(19) United States
(12) Patent Application Publication
(10) Pub. No.: US 2015/0154695 A1
(43) Pub. Date: Jun. 4, 2015

(54) FORECASTING LAGGED CURRENT TRANSACTIONS BASED ON PRIOR TRANSACTIONS

(71) Applicant: Mastercard International Corporation, Purchase, NY (US)

(72) Inventors: Kenny UNSER, Fairfield, CT (US); Serge BERNARD, Danbury, CT (US); Nikhil MALGATTI, Stamford, CT (US)

(73) Assignee: MASTERCARD INTERNATIONAL CORPORATION, Purchase, NY (US)

(21) Appl. No.: 14/095,484

(22) Filed: Dec. 3, 2013

(51) Int. Cl. G06Q 40/00

(52) U.S. Cl. CPC G06Q 40/00

(57) ABSTRACT

An economic performance forecasting system includes computer storage configured to store payment card transaction records. A computer processor is configured to access the computer storage and determine from the stored payment card transaction records a total (T_{ToDate}) of transaction amounts for transaction records having a transaction date and a process date during a current period as of a current date. The processor determines from the stored payment card transaction records a total (P_{ToDate}) of transaction amounts for transaction records having a transaction date in prior period and having a process date equal to or earlier than a prior date. The computer processor determines a relationship between T_{ToDate} and P_{ToDate}.

### BACKGROUND

1. Field of the Disclosure

The present disclosure relates generally to the field of merchant performance forecasting, and more particularly to methods, systems and computer program products that use lagged payment card transaction data to forecast total current transaction data.

2. Description of the Related Art

Forecasting enterprise performance is a large and important business. Publicly traded companies publish their performance quarterly. However, to ensure the accuracy of their reported performance, there is typically a delay of several weeks between the end of a quarter and the date the company reports its results. Industry and financial analysts publish or otherwise make available to competitors and investors estimates of a company's performance before the company makes its reports. Early and accurate estimates are extremely valuable to investors and other decision makers.

A huge amount of commerce is performed using payment cards. For example, almost all of the purchases from on-line retailers are made with payment cards. A substantial amount of purchases from “brick and mortar” retailers are made using payment cards. Payment card processors process millions of transactions every day. Accordingly, payment card processors have a substantial amount of information about a particular company's sales and overall retail conditions in the economy.

There can be a substantial lag between the date a payment card transaction occurs and the date the payment card processor actually processes the transaction. For example, restaurants usually submit transaction records for processing at least a day after the meal so that the manager can add tips to the bill. Some retailers may not submit their transaction records for processing until they have shipped the goods, which may be several days after the date of the purchase transaction. In the travel and hotel businesses, there may be a lag of several months between the time the customer books a trip or a room and the time the customer actually makes the trip or uses the room.

Eventually, the payment card processor has data on every transaction it processed over any particular period. However, because of the lag between the transaction date and the processing date, the payment card processor typically has an incomplete view of current payment card activity.

### SUMMARY

Embodiments include methods, systems, and computer-readable media that use stored payment card transaction records to forecast economic performance for a current period based upon transaction totals for a prior period.

In one aspect, a method of forecasting economic performance includes accessing, with a computer processor, payment card transaction records stored in computer storage, wherein each payment card transaction record includes a transaction date, a process date and a transaction amount. The method determines from the stored payment card transaction records a total (T_{ToDate}) of transaction amounts for transaction records having a transaction date and a process date during a current period as of a current date, wherein the current period includes a start date and an end date, and wherein the current date has a relationship to the start date or the end date of the of the current period. The method determines from the stored payment card transaction records a total (P_{ToDate}) of transaction amounts for transaction records having a transaction date in prior period and having a process date equal to or earlier than a prior date, wherein the prior period includes a start date and an end date, and wherein the prior date has the same relationship to the start date or the end date of the of the prior period as the current date has to the start date or the end date of the of the current period. The method determines a relationship between T_{ToDate} and P_{ToDate} periods.

In another aspect, an economic performance forecasting system includes computer storage configured to store payment card transaction records, wherein each payment card transaction record includes a transaction date, a process date and a transaction amount. A computer processor configured to access the computer storage and determine from the stored payment card transaction records a total (T_{ToDate}) of transaction amounts for transaction records having a transaction date and a process date during a current period as of a current date, wherein the current period includes a start date and an end date, and wherein the current date has a relationship to the start date or the end date of the of the current period. The computer processor determines from the stored payment card transaction records a total (P_{ToDate}) of transaction amounts for transaction records having a transaction date in prior period and having a process date equal to or earlier than a prior date, wherein the prior period includes a start date and an end date, and wherein the prior date has the same relationship to the start date or the end date of the of the prior period as the current date has to the start date or the end date of the of the current period. The computer processor determines a relationship between T_{ToDate} and P_{ToDate}.

In another aspect, a non-transitory computer-readable storage medium encoded with data and instructions, which when executed by a computing device the instructions causes the computing device to access payment card transaction records stored in computer storage, wherein each payment card transaction record includes a transaction date, a process date and a transaction amount. The instructions cause the computing device to determine from the stored payment card transaction records a total (T_{ToDate}) of transaction amounts for transaction records having a transaction date and a process date during a current period as of a current date, wherein the current period includes a start date and an end date, and wherein the current date has a relationship to the start date or the end date of the of the current period. The instructions cause the computing device to determine from the stored payment card transaction records a total (P_{ToDate}) of transaction amounts for transaction records having a transaction date in prior period and having a process date equal to or earlier than a prior date, wherein the prior period includes a start date and an end date, and wherein the prior date has the same relationship to the start date or the end date of the of the prior period as the current date has to the start date or the end date of the of the current period. The instructions cause the computing device to determine a relationship between T_{ToDate} and P_{ToDate}.

### BRIEF DESCRIPTION OF THE DRAWINGS

The disclosure will best be understood by reference to the following detailed description of an illustrative embodiment when read in conjunction with the accompanying drawings, where:

FIG. 1 is a block diagram of an embodiment of a payment card clearing and transaction data forecasting system;

FIG. 2 is a pictorial representation of an embodiment of a payment card transaction and process date record database;

FIG. 3 is a pictorial representations of embodiments of a payment card transaction forecaster user interface screen;

FIG. 4 is a flowchart of an embodiment of payment card clearing management processor transaction record storage processing;

FIG. 5 is a flowchart of an embodiment of payment card lagged transaction forecasting processing; and,

FIG. 6 is a block diagram of a computing device in which embodiments of the present disclosure may be implemented.

### DETAILED DESCRIPTION

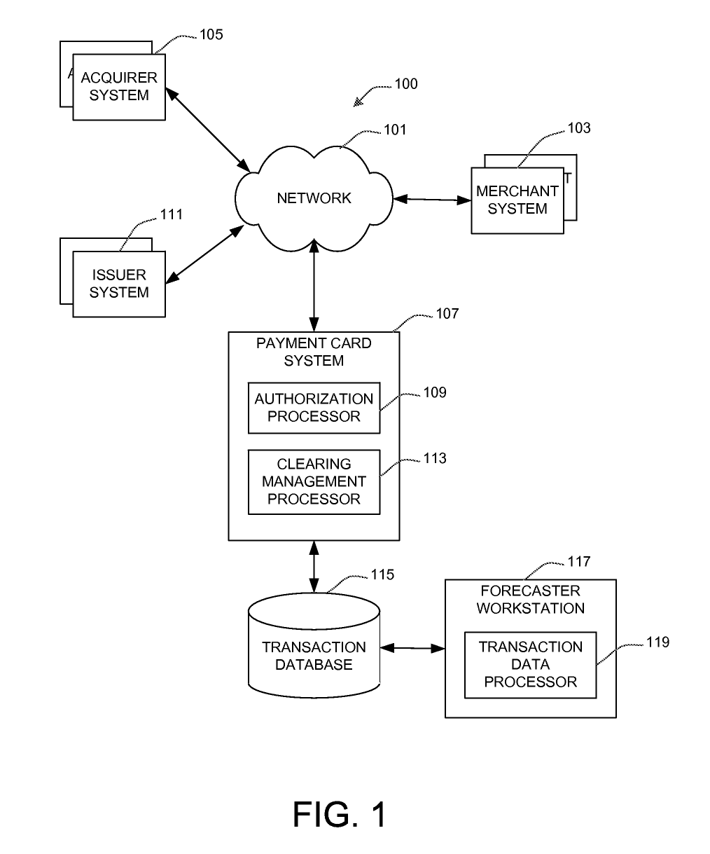

Referring now to the drawings, and first to FIG. 1, an embodiment of a payment card clearing and transaction data forecasting system is designated generally by the numeral 100. As used herein, a payment card is any credit card, debit card, prepaid card or the like, or any virtual type of account not involving a physical card, such as an electronic wallet, or the like, that is issued to a cardholder and that is used to purchase goods and/or services. System 100 includes a network, designated generally by the numeral 101. Network 101 can comprise one or more interconnected networks, such as the Internet.

A plurality of merchant systems 103 are connected to network 101. Merchant systems 103 include computing devices that collect point-of-sale information, such as payment card number and transaction amount, for use in authorization processing, and store transaction information for use in clearing and settlement processing.

Authorization is the process by which wherein a merchant system 103 determines whether or not a particular payment card transaction will be honored. Merchant system 103 transmits an authorization request, which includes payment card and transaction information, over network 101 to one of a plurality of acquirer systems 105. An acquirer system 105 is a computer system at a financial institution, such as a bank, with which the merchant associated with merchant system 103 has an account. The transaction information includes at least the amount of the transaction.

Acquirer system 105 transmits the authorization request received from merchant system 103 over network 101 to a payment card system 107. Payment card system 107 includes an authorization processor 109, which is a computer or server that determines the issuer of the payment card identified in the authorization request. An issuer is a financial institution that issues payment cards to, and maintains accounts in the name of, cardholders. Authorization processor 109 transmits the authorization request over network 101 to an identified issuer system 111.

The identified issuer system 111 receives the authorization request and determines whether or not to authorize the transaction. In the case of debit card transactions, issuer system 111 determines, among other things, whether account associated with card has sufficient funds to cover the transaction. In the case of credit card transactions, issuer system 111 determines, among other things, whether the account associated with the card has sufficient credit to cover the transaction. Depending on the determination, issuer system 111 transmits to payment card system 107 an authorization response that authorizes or declines the transaction. Payment card system 107 forwards the authorization response to acquirer system 105, which in turn forwards the authorization response to merchant system 103. If the authorization response indicates that the transaction is authorized, the merchant associated with merchant system 103 completes the transaction, for example by delivering or promising to deliver goods to the holder of the payment card. The date merchant system 103 receives the authorization response is the transaction date.

The processes of clearing and settling payment card transactions involves transferring funds from an account at the issuing financial institution to an account at the acquiring financial institution, with the issuing financial institution, payment card network and acquiring financial institution each receiving a fee. Merchant system 103 transmits transaction records, which include the merchant's identifying information, the transaction date, and the transaction amount, via network 101 to acquirer system 105. Acquirer system 105 transmits the transaction records over network 101 to payment card system 107, where a clearing management processor determines to which issuer system 111 to transmit a particular transaction record. As will be described in detail hereinafter, clearing management processor 113 also extracts from the transaction record the merchant's name, the transaction date and the transaction amount in a transaction database 115. Clearing management processor 113 stores in transaction database 115 not only the extracted transaction information, but also the date it received and processed the transaction record, which is known as the process date for the transaction.

When issuer system 111 receives the transaction record from payment card system 107 via network 101, issuer system 111 transmits funds in the amount of the transaction amount, less its fees, back to payment card system 107. Payment card system 107 transfers to acquirer system 105 funds in the amount of the funds it received from issuer system 111, less its fees. Finally, acquire system deposits in an account associated with the merchant funds in the amount it received from payment card system 107, less its fees, thereby settling the transaction.

The clearing and settlement processes typically do not occur immediately upon completion of the transaction. Instead, merchant system 103 typically accumulates transactions according to its clearing and settlement policies before transmitting them in batches over network 101 to acquirer system 105 to initiate the clearing and settlement processes. Merchant system 103 typically transmits batches of transaction records as part of its end of day processing. However, a merchant may not schedule transaction record for transmission until, for example, it has shipped the goods of the transaction. Accordingly, the process date may lag the transaction date by several days or even longer.

According to embodiments of the present disclosure, system 100 includes a forecaster workstation 117. Forecaster workstation 117 can be a personal computer, or the like, configured to execute a transaction data processor 119. As will be described in detail hereinafter, transaction data processor 119 accesses transaction database 115 and makes forecasts of transaction amounts or volume over current periods based upon transaction data stored for prior periods.

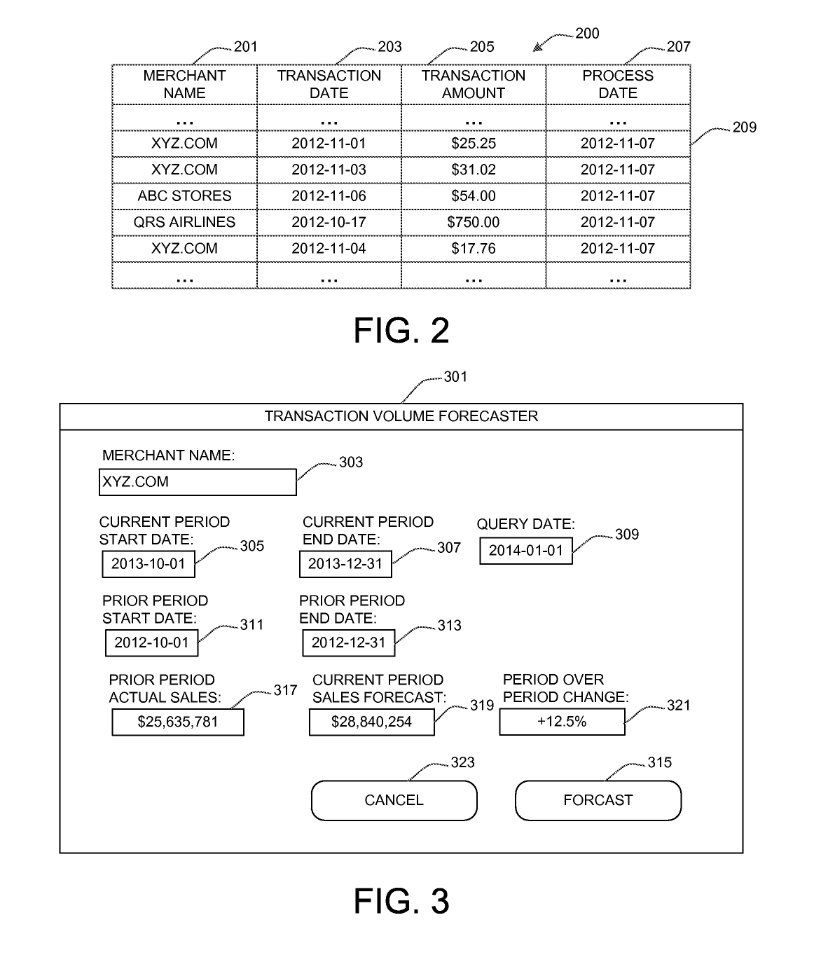

FIG. 2 is a pictorial representation of an embodiment of transaction data 200 stored in transaction database 115. Transaction database 115 may be a relational database, whereby transaction records may be sorted according to various criteria. Transaction data 200 is stored in tabular form comprising a merchant name column 201, a transaction date column 203, a transaction amount column 205 and process date column 207. Each transaction record in transaction data 200 is represented by a line. Thus, line 209, for example, represents a transaction in the amount of $25.25 dated Nov. 1, 2012 for a merchant XYZ.COM, which was processed Nov. 7, 2012.

FIG. 3 is a pictorial representation of a transaction volume forecaster screen 301, which can be displayed on a display (not shown) of forecaster workstation 117. Forecaster screen 301 includes various text entry fields into which an analyst can enter information to cause transaction data processor 117 to access transaction database 115 and forecast transaction volume for a selected current period based upon transaction volume for a selected prior period. More particularly, volume forecaster screen 301 includes a merchant name field 303 into which the analyst has entered XYZ.COM, a current period start date field 305 into which the analyst has enter Oct. 1, 2013, a current period end date field 307 into which the analyst has enter Dec. 31, 2013, and a current date filed 309 into which the analyst has enter Jan. 1, 2014. Thus, on Jan. 1, 2014, the analyst seeks a forecast of sales by XYZ.COM for the fourth quarter of 2013.

In the example of FIG. 3, the forecast is based on sales by XYZ.COM, in a prior period, which is the fourth quarter of 2012. Thus, forecaster screen 301 includes a prior period start date field 311 into which the analyst has enter Oct. 1, 2012, and a prior period end date field 313 into which the analyst has enter Dec. 31, 2012. After the analyst has filed in fields 303-313, the analyst can actuate a FORECAST button 315, which will cause transaction data processor 119 to make the forecast and display other analytical information. In the example of FIG. 3, XYZ.COM had actual payment card sales of $25,635,781 in the fourth quarter of 2012, as shown in field 317. According to embodiments of the present disclosure, as of Jan. 1, 2014, XYZ.COM is forecast to have payment card sales of $28,840,254 in the fourth quarter of 2013, as shown in field 319, for a period over period increase of 12.5%, as shown in FIG. 321. The analyst can cancel the forecast by actuating a CANCEL button 323.

Although in the example of FIG. 3, the current date is after the end date of the current period, it will be recognized that the current date can be before the end date of the current period. For example, the analyst may wish to forecast sales for the fourth quarter of 2013 based upon stored payment card transactions processed as of Oct. 31, 2013. In that case, the analyst would enter “2013-10-31” in entry field 309.

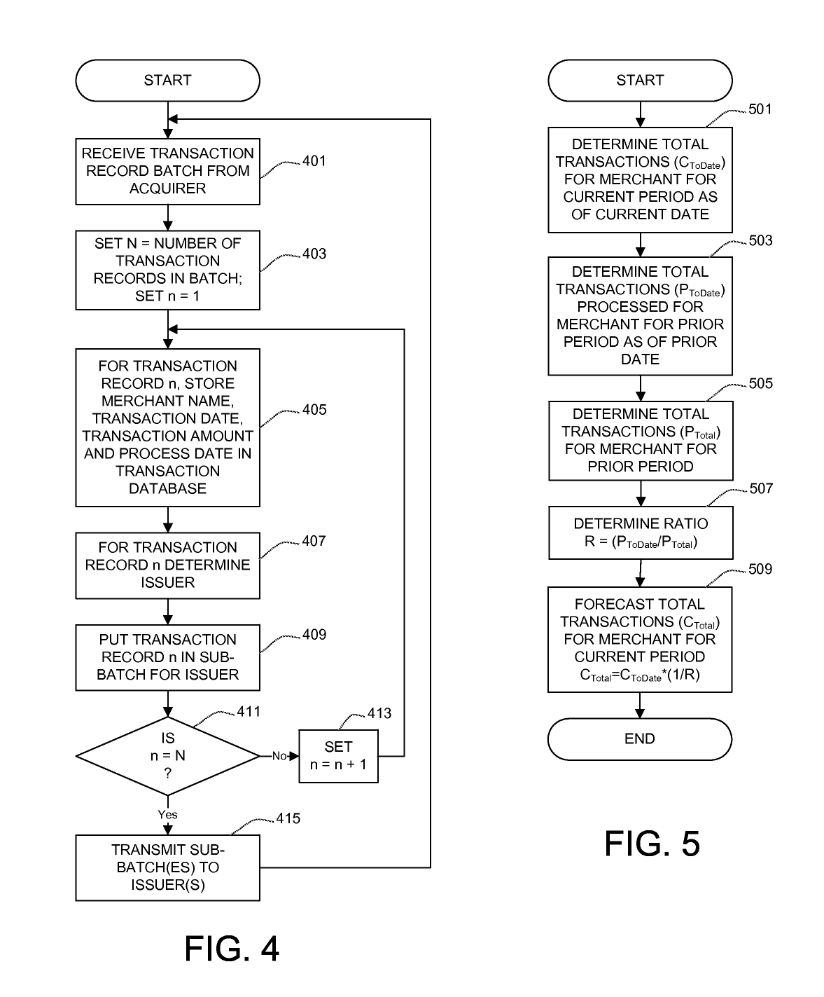

FIG. 4 is a flowchart of an embodiment of clearing management processor 113 processing. Clearing management processor 113 receives a batch of transaction records from an acquirer system, as indicated at block 401. Clearing management processor 113 sets a constant N equal to the number of transaction records in the batch, and sets n=1, as indicated at block 403. Then, clearing management processor 113 stores in transaction database 115 the merchant name, transaction date, transaction amount and process date for transaction record n, as indicated at block 405. Clearing management processor 113 then determines, at block 407, the issuer associated with transaction n, and puts transaction record n in a sub-batch for transmission to the issuer, as indicated at block 409. Then, clearing management processor 113 determines, at decision block 411, if n is equal to N. If n is not equal to N, clearing management processor 113 sets n equal to n plus 1, at block 413, and returns to block 405. If n is equal to N, then clearing management processor 113 transmits the sub-batch or sub-batches to the appropriate issuer or issuers, as indicated at block 415, and returns to block 401 to await another batch from an acquirer.

FIG. 5 is a flowchart of an embodiment of transaction data processor 119 processing. Transaction data processor 119 accesses transaction database 115 and determines the total payment card transactions (C_{ToDate}) processed for a selected merchant for a current period as of a current date, as indicated at block 501. C_{ToDate} is the total of transactions in transaction database 115 for the merchant and having a transaction date and a process date in the current period. Transaction data processor 119 then determines the total transactions (P_{ToDate}) processed for the selected merchant as of a prior date, as indicated at block 503. The prior date has the same relationship to the start date or the end date of the prior period as the current date has to start date or the end date the current period. For example, consider the current period is the just finished business quarter and the prior period is the immediately preceding business quarter. If the current date is the second calendar date following the end of the current quarter, then the prior date is the second calendar date following the end of the immediately preceding business quarter. P_{ToDate} is the total of transactions in transaction database 115 for the merchant and having a transaction date in the prior period and a process date the prior date. After determining P_{ToDate} at block 503, transaction data processor 119 determines the total payment card transactions (P_{Total}) for the selected merchant having a transaction date in prior period, as indicated at block 505.

After making the determinations according to blocks 503 and 505, transaction data processor 119 determines the ratio R of the total transactions P_{ToDate} processed for the selected merchant as of prior date to total payment card transactions P_{Total} for the selected merchant for the prior period (R=P_{ToDate}/P_{Total}), as indicated at block 507. Then, transaction data processor 119 calculates a forecast of total transactions (C_{Total}) for the current period by multiplying the total payment card transactions (C_{ToDate}) processed for the merchant for the current period as of the current date by the reciprocal of the ratio (C_{Total}=C_{ToDate}*(1/R), as indicated at block 509.

It will be recognized that the steps of blocks 501-509 can be performed in different orders and that some steps can be performed independent of other steps. Forecast total sales for a current period C_{Total} is calculated according to the equation

$${C}_{Total} = \frac{{C}_{ToDate} * {P}_{Total}}{{P}_{ToDate}} . \qquad ( 1 )$$

In the embodiment of FIG. 5, equation (1) is effectively rewritten as

$${C}_{Total} = ( \frac{{P}_{Total}}{{P}_{ToDate}} ) * {C}_{ToDate} . \qquad ( 2 )$$

The expression

$$\frac{{P}_{Total}}{{P}_{ToDate}}$$

is the ratio of total payment card transactions for the prior period to the total of payment card transactions for the prior period that were processed as of the prior date. The inverse of

$$\frac{{P}_{Total}}{{P}_{ToDate}}$$

can be thought of as the percentage the total of payment card transactions for the prior period that were processed as of the prior date. Thus, for example, if it is determined that twenty percent of the prior period payment card transactions were processed as of the prior date, it can be forecast that current period payment card transactions as of the current date represent twenty percent of the total current period payment card transactions.

Equation (1) can also be rewritten as

$${C}_{Total} = ( \frac{{C}_{ToDate}}{{P}_{ToDate}} ) * {P}_{Total} . \qquad ( 3 )$$

The expression

$$\frac{{C}_{ToDate}}{{P}_{ToDate}}$$

is the ratio of total current payment card transaction processed as of the current date to total prior payment card transactions processed as of the prior date. For example, if

$$\frac{{C}_{ToDate}}{{P}_{ToDate}}$$

is equal to 1.1 it can be forecast that current period sales are running fifteen percent ahead of prior period sales.

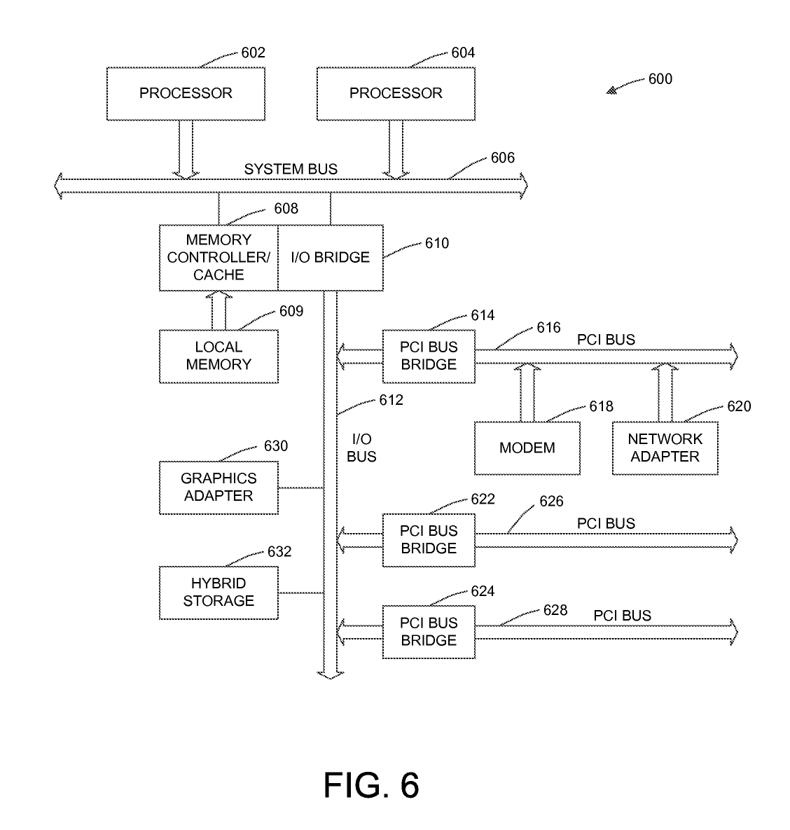

FIG. 6 is a block diagram of a data processing system upon which embodiments of the present disclosure may be implemented. Data processing system 600 may be a symmetric multiprocessor (SMP) system including a plurality of processors 602 and 604 connected to system bus 606. Alternatively, a single processor system may be employed. Also connected to system bus 606 is memory controller/cache 608, which provides an interface to local memory 609. I/O bridge 610 is connected to system bus 606 and provides an interface to I/O bus 612. Memory controller/cache 608 and I/O bridge 610 may be integrated as depicted.

Peripheral component interconnect (PCI) bus bridge 614 connected to I/O bus 612 provides an interface to PCI local bus 616. A number of modems may be connected to PCI local bus 616. Typical PCI bus implementations will support four PCI expansion slots or add-in connectors. Communications links to networks may be provided through a modem 618 or a network adapter 620 connected to PCI local bus 616 through add-in boards. Additional PCI bus bridges 622 and 624 provide interfaces for additional PCI local buses 626 and 628, respectively, from which additional modems or network adapters may be supported. In this manner, data processing system 600 allows connections to multiple network computers. A memory-mapped graphics adapter 630 and hybrid storage 632 may also be connected to I/O bus 612 as depicted, either directly or indirectly.

Those of ordinary skill in the art will appreciate that the hardware depicted in FIG. 6 may vary. For example, other peripheral devices, such as optical disk drives and the like, also may be used in addition to or in place of the hardware depicted. The depicted example is not meant to imply architectural limitations with respect to the present disclosure.

The data processing system depicted in FIG. 6 may be, for example, an IBM® eServer™ pSeries system, a product of International Business Machines Corporation in Armonk, N.Y., running the Advanced Interactive Executive (AIX™) operating system or LINUX® operating system.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage medium or media having computer readable program code embodied thereon.

Any combination of one or more computer readable storage medium or media may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program instructions comprising the program code for carrying out aspects of the present disclosure may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable storage medium that can direct a computer, other programmable data processing apparatus, or other devices to function in a particular manner, such that the instructions stored in the computer readable medium produce an article of manufacture including instructions which implement the function/act specified in the foregoing flowchart and/or block diagram block or blocks.

The computer program instructions may also be loaded onto a computer, other programmable data processing apparatus, or other devices to cause a series of operations to be performed on the computer, other programmable apparatus or other devices to produce a computer implemented process such that the instructions which execute on the computer or other programmable apparatus provide processes for implementing the functions/acts specified in the foregoing flowchart and/or block diagram block or blocks.

The flowcharts and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, processes, operations, elements, and/or components, but do not preclude the presence or addition of one or more other features, integers, processes, operations, elements, components, and/or groups thereof.

The corresponding structures, materials, acts, and equivalents of all elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

From the foregoing, it will be apparent to those skilled in the art that systems and methods according to the present disclosure are well adapted to overcome the shortcomings of the prior art. While the present disclosure has been described with reference to the above embodiments, those skilled in the art, given the benefit of the foregoing description, will recognize alternative embodiments. Accordingly, the foregoing description is intended for purposes of illustration and not of limitation.

What is claimed is:

1. A method of forecasting economic performance, comprising:
accessing, with a computer processor, payment card transaction records stored in computer storage, wherein each payment card transaction record includes a transaction date, a process date and a transaction amount;
determining, with the computer processor, from the stored payment card transaction records a total (T_{ToDate}) of transaction amounts for transaction records having a transaction date and a process date during a current period as of a current date, wherein the current period includes a start date and an end date, and wherein the current date has a relationship to the start date or the end date of the of the current period;
determining, with the computer processor, from the stored payment card transaction records a total (P_{ToDate}) of transaction amounts for transaction records having a transaction date in prior period and having a process date equal to or earlier than a prior date, wherein the prior period includes a start date and an end date, and wherein the prior date has the same relationship to the start date or the end date of the of the prior period as the current date has to the start date or the end date of the of the current period; and,
determining, with the computer processor, a relationship between T_{ToDate} and P_{ToDate}.

2. The method as claimed in claim 1, wherein the relationship is T_{ToDate} divided by P_{ToDate}.

3. The method as claimed in claim 1, further comprising:
determining, with the computer processor, from the stored payment card transaction records a total P_{Total} of transaction amounts for transaction records having a transaction date during the prior period; and,
applying, with the computer processor, to P_{Total} the relationship between T_{ToDate} and P_{ToDate} to forecast a total (C_{Total}) of transaction amounts for the current period.

4. The method as claimed in claim 3, wherein applying further comprises:
multiplying P_{Total} by T_{ToDate} divided by P_{ToDate} to obtain C_{Total}.

5. The method as claimed in claim 1, wherein:
each transaction record includes a merchant name and the relationship between T_{ToDate} and P_{ToDate} is determined for the merchant.

6. The method as claimed in claim 1, wherein:
the current period is in a current year and the prior period has the same start date and end date in a prior year.

7. The method as claimed in claim 1, wherein:
the start date is equal to the end date of the first period in current period, and the start date is equal to end date of the second period in prior period.

8. The method as claimed in claim 1, wherein:
the relationship of the current date to the start date or the end date of the of the current period is after the start date of the current period and before the end date of the current period.

9. The method as claimed in claim 1, wherein:
the relationship of the current date to the start date or the end date of the of the current period is on or after the end date of the current period.

10. A system of forecasting economic performance, comprising:
computer storage configured to store payment card transaction records, wherein each payment card transaction record includes a transaction date, a process date and a transaction amount;
a computer processor configured to access the computer storage and:
determine from the stored payment card transaction records a total (T_{ToDate}) of transaction amounts for transaction records having a transaction date and a process date during a current period as of a current date, wherein the current period includes a start date and an end date, and wherein the current date has a relationship to the start date or the end date of the of the current period;
determine from the stored payment card transaction records a total (P_{ToDate}) of transaction amounts for transaction records having a transaction date in prior period and having a process date equal to or earlier than a prior date, wherein the prior period includes a start date and an end date, and wherein the prior date has the same relationship to the start date or the end date of the of the prior period as the current date has to the start date or the end date of the of the current period; and,
determine a relationship between T_{ToDate} and P_{ToDate}.

11. The system as claimed in claim 10, wherein the relationship is T_{ToDate} divided by P_{ToDate}.

12. The system as claimed in claim 10, wherein the computer processor is further configured to:
determine from the stored payment card transaction records a total P_{Total} of transaction amounts for transaction records having a transaction date during the prior period; and,
apply to P_{Total} the relationship between T_{ToDate} and P_{ToDate} to forecast a total (C_{Total}) of transaction amounts for the current period.

13. The system as claimed in claim 12, wherein the computer processor applies to P_{Total} Total the relationship between T_{ToDate} and P_{ToDate} by multiplying P_{Total} Total by T_{ToDate} divided by P_{ToDate} to obtain C_{Total}.

14. The system as claimed in claim 10, wherein:
each transaction record includes a merchant name and the relationship between T_{ToDate} and P_{ToDate} is determined for the merchant.

15. A non-transitory computer-readable storage medium encoded with data and instructions, which when executed by a computing device the instructions causing the computing device to:
access payment card transaction records stored in computer storage, wherein each payment card transaction record includes a transaction date, a process date and a transaction amount;
determine from the stored payment card transaction records a total (T_{ToDate}) of transaction amounts for transaction records having a transaction date and a process date during a current period as of a current date, wherein the current period includes a start date and an end date, and wherein the current date has a relationship to the start date or the end date of the of the current period;
determine from the stored payment card transaction records a total (P_{ToDate}) of transaction amounts for transaction records having a transaction date in prior period and having a process date equal to or earlier than a prior date, wherein the prior period includes a start date and an end date, and wherein the prior date has the same relationship to the start date or the end date of the of the prior period as the current date has to the start date or the end date of the of the current period; and,
determine a relationship between T_{ToDate} and P_{ToDate}.

16. The non-transitory computer-readable storage medium of claim 15, wherein the relationship is T_{ToDate} divided by P_{ToDate}.

17. The non-transitory computer readable storage medium as claimed in claim 15, further comprising data and instructions, which when executed by a computing device the instructions causing the computing device to:
determine from the stored payment card transaction records a total P_{Total} of transaction amounts for transaction records having a transaction date during the prior period; and,
apply to P_{Total} Total the relationship between T_{ToDate} and P_{ToDate} to forecast a total (C_{Total}) of transaction amounts for the current period.

18. The non-transitory computer readable storage medium as claimed in claim 17, wherein the instructions apply to P_{Total} Total the relationship between T_{ToDate} and P_{ToDate} by multiplying P_{Total} Total by T_{ToDate} divided by P_{ToDate} to obtain C_{Total}.

19. The non-transitory computer readable storage medium as claimed in claim 15, wherein:
each transaction record includes a merchant name and the relationship between T_{ToDate} and P_{ToDate} is determined for the merchant.

20. The non-transitory computer-readable storage medium of claim 15, wherein:
the current period is in a current year and the prior period has the same start date and end date in a prior year.
